(19) United States
(12) Patent Application Publication
(10) Pub. No.: US 2023/0400101 A1
(43) Pub. Date: Dec. 14, 2023

(54) SLIDE RING SEAL ASSEMBLY SECURED AGAINST DISENGAGEMENT

(71) Applicant: EagleBurgmann Germany GmbH & Co. KG, Wolfratshause (DE)

(72) Inventors: Ferdinand Werdecker, Walchensee (DE); Florian Bauer, Oberfischbach (DE)

(73) Assignee: EagleBurgmann Germany GmbH & Co. KG, Wolfratshausen (DE)

(21) Appl. No.: 18/033,447

(22) PCT Filed: Oct. 19, 2021
(86) PCT No.: PCT/EP2021/078937

§ 371 Date: Apr. 24, 2023

(30) Foreign Application Priority Data
Oct. 29, 2020 (DE) 10 2020 128 414.4

(51) Int. Cl. F16J 15/34

(52) U.S. Cl. CPC F16J 15/3464; F16J 15/3436

(57) ABSTRACT

The invention relates to a mechanical seal arrangement comprising a mechanical seal (2) having a rotating sliding ring (3) and a stationary sliding ring (4) defining a sealing gap (5) between the sealing surfaces (30, 40) thereof, a slide ring carrier (6) for holding the stationary sliding ring (4), an axially movable thrust ring (7) arranged on a rear side (43) of the stationary sliding ring (4) between the slide ring carrier (6) and the stationary sliding ring, a pretensioning device (8) arranged between the thrust ring (7) and the slide ring carrier (6) to pretension the stationary sliding ring (4) in the axial direction X-X of the mechanical seal arrangement, and an anti-rotation device (10) to keep the stationary sliding ring (4) rotationally fixed and axially movable, the anti-rotation device (10) having a first transmission device (11) for transmitting force between the sliding ring carrier (6) and the thrust ring (7) and a second transmission device (12) for transmitting force between the thrust ring (7) and the stationary sliding ring (4), and wherein a locking element (13) is arranged on the first transmission device (11) to secure the thrust ring (7) against axial disengagement.

The present invention relates to a mechanical seal arrangement with anti-disengagement device, in particular to ensure safe and secure assembling and disassembling by an assembly technician.

Mechanical seal arrangements are known from prior art in various configurations. Depending on the intended use, mechanical seal arrangements can have diameters of 1 m and more. Assembling and disassembling the components of the mechanical seal arrangement, means that an assembly technician has to handle components of very heavy weights. In addition, mechanical seal assembling often is to be performed under severe conditions, for example off-shore or in very cold or hot climates. It may also happen, for example, when it is required to replace sliding rings of the mechanical seal arrangement due to wear of the sliding rings, that the components of the mechanical seal arrangement get stuck and can only be loosened using strong force, e.g. hammer blows. Since mechanical seal arrangements usually have pretensioning devices, for example springs or the like, sudden component loosening in the mechanical seal may occur, and sudden component loosening may be exacerbated by tension release occurring in the pretensioning devices.

It is the object of the present invention to provide a mechanical seal arrangement which can prevent occurrence of sudden, unexpected component loosening in mechanical seal arrangement, while maintaining a simple and inexpensive structure.

This object will be achieved by providing a mechanical seal arrangement having the features of claim 1. The subclaims preferably show further embodiments of the invention.

The mechanical seal arrangement according to the invention having the features of claim 1 thus has the advantage, compared with the solutions which have been known so far, that assembly and disassembly of components of the mechanical seal arrangement may be done in a significantly simplified and safer manner. In particular, handling can be made much easier on construction sites. No additional heavy, separate assembly aids are required therewith. It is also possible that less skilled assembly technicians can perform assembly and disassembly of the mechanical seal arrangement, for example in case of emergency, if required. Furthermore, the invention prevents the risk of damage to the secondary seals when sliding rings are to be replaced. According to the invention, this will be achieved by providing the mechanical seal arrangement with a mechanical seal having a rotating and a stationary sliding ring, which define a sealing gap between the sealing surfaces thereof. Furthermore, a sliding ring carrier is provided for retaining the stationary sliding ring on a stationary component. An axially movable thrust ring is arranged on a rear side of the stationary sliding ring between the sliding ring carrier and the rotating sliding ring. Furthermore, a pretensioning device is provided, for example a plurality of springs, which is arranged between the thrust ring and the seal ring carrier. The pretensioning device pretensions the stationary sliding ring in the axial direction of the mechanical seal arrangement. Furthermore, an anti-rotation device is provided to keep the stationary sliding ring non-rotatable and axially movable. The anti-rotation device comprises a first transmission device for transmitting force between the sliding ring carrier and the thrust ring, and a second transmission device for transmitting force between the thrust ring and the stationary sliding ring. A locking element is arranged on the first transmission device to secure the thrust ring from axially disengaging. This allows disassembly of the two sliding rings without having to demount the thrust ring and the pretensioning device.

Preferably, the first transmission device is a pin, in particular a cylindrical pin. Most preferably, several pins are provided along the circumference to form the first transmission device.

Preferably, the locking element of the anti-rotation device is a locking washer. Most preferably, the locking washer is arranged in a groove in the pin.

Further preferably, the second transmission device is a pin, in particular a cylindrical pin. Most preferably, the second transmission device comprises a plurality of pins.

The use of pins as a first and/or second transmission device enables simple assembling and disassembling in the axial direction and also simple connection operations between the pins and the components, for example by means of a press fit.

Most preferably, the sliding ring carrier comprises a base region and a first axial extension region, which radially extends outside the stationary sliding ring. In this way, the slide ring carrier overlaps the stationary sliding ring and still allows axial removal and installation of the stationary sliding ring.

Most preferably, the slide ring carrier is formed to have a substantially C-shaped cross-section, and has a second axial extension region in addition to the base region and the first axial extension region. The two axial extension regions are connected to each other by the base region, accommodating the stationary sliding ring between them.

Most preferably, the stationary sliding ring has a first recess for the first transmission device. The first recess preferably is a blind hole.

Further preferably, the thrust ring has a second recess through which the first transmission device is passed. The second recess preferably is a cylinder bore.

Most preferably, a first and a second secondary seal is arranged on the thrust ring on a thrust ring side facing the rear side of the stationary sliding ring. This allows the stationary sliding ring to be demounted in the axial direction without having to demount the two secondary seals. Another advantage is that the two secondary seals may also be replaced without difficulty and the stationary sliding ring may then be assembled without any risk of damage to the two secondary seals.

Further preferably, the rotating sliding ring is connected to a sleeve which can be fixed to a rotating component, for example a shaft. This allows the entire mechanical seal arrangement to be provided as an assembly and thus to be completely assembled and disassembled as an assembly. In the assembled state, the sliding rings and secondary seals may individually be replaced without having to demount the remaining components of the mechanical seal arrangement, in particular the slide ring carrier and the thrust ring as well as the pretensioning device.

In the following, a preferred embodiment of the invention will be described in detail while reference will be made to the accompanying drawing, wherein:

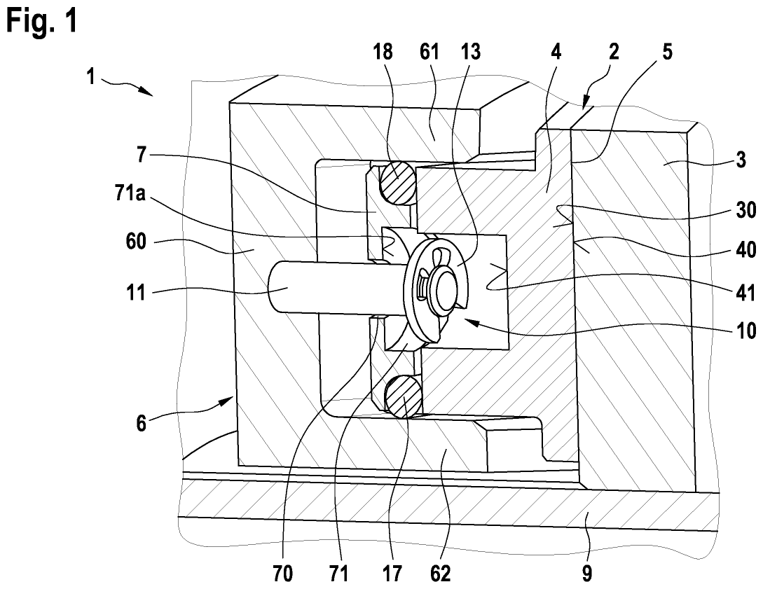

FIG. 1 is a schematic, perspective partial sectional view of a mechanical seal arrangement according to a preferred example embodiment of the invention,

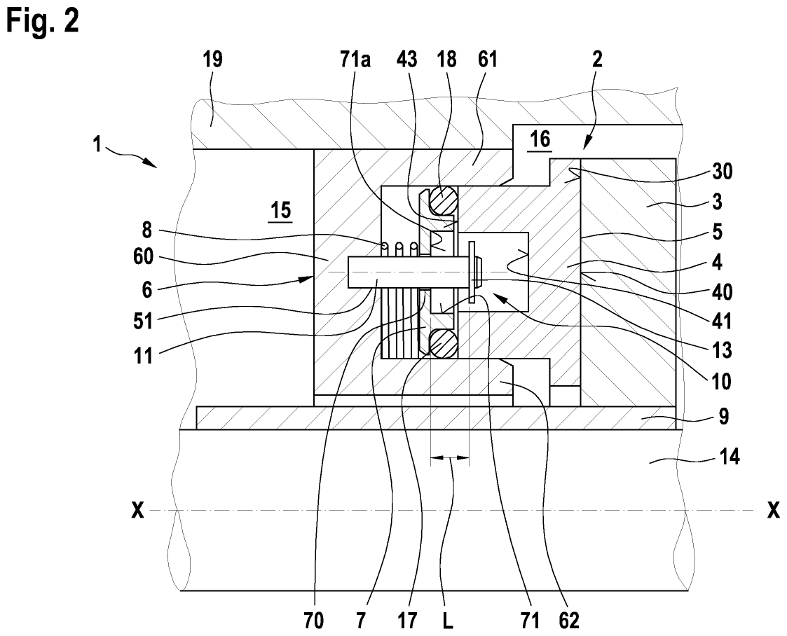

FIG. 2 is a schematic, partial sectional view of the mechanical seal arrangement of FIG. 1 in a first sectional plane, and

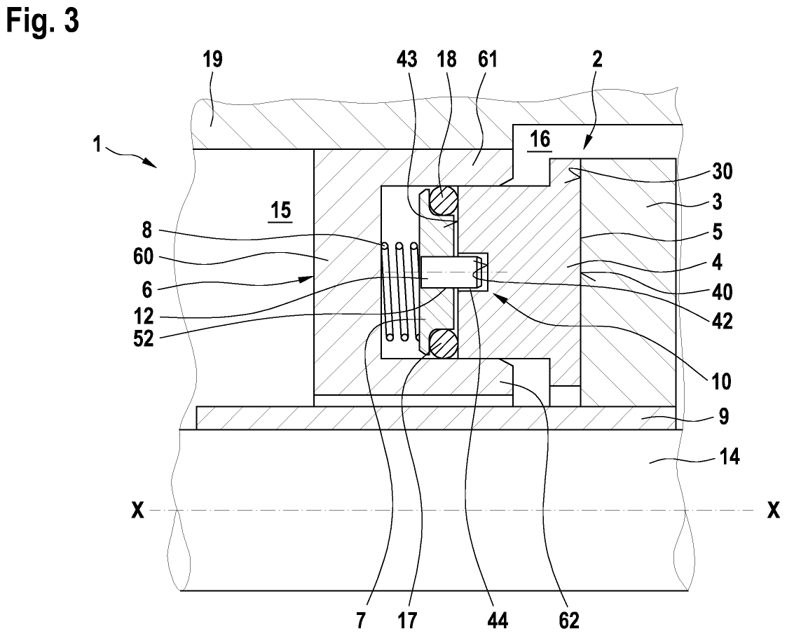

FIG. 3 is a schematic partial sectional view of the mechanical seal arrangement of FIG. 1 in a second sectional plane.

Hereinafter, a mechanical seal arrangement 1 according to a preferred example embodiment of the invention will be described in detail while reference will be made to FIGS. 1 to 3.

The mechanical seal arrangement 1 seals a product region 15 from an atmosphere region 16 on a shaft 14 and a housing 19.

As may be seen from FIGS. 1 to 3, the mechanical seal arrangement 1 comprises a mechanical seal 2 having a rotating sliding ring 3 and a stationary sliding ring 4. A sealing gap 5 is defined between a sliding surface 30 of the rotating sliding ring 3 and a sliding surface 40 of the stationary sliding ring 4. The rotating sliding ring 3 is mounted on a sleeve 9.

The mechanical seal arrangement 1 further comprises a slide ring carrier 6, which has substantially a C-profile in cross-section. The slide ring carrier 6 is attached to the housing 19. In this regard, the slide ring carrier 6 comprises a base portion 60 extending in the radial direction, and a first outer extension portion 61 extending in the axial direction and a second inner extension portion 62 extending in the axial direction. The outer and inner extension portions 61, 62 are parallel to each other and have an equal length in the axial direction. The stationary sliding ring 4 is partially accommodated between the two extension regions 61, 62, as may be seen from FIGS. 1 to 3. The two extension regions 61, 62 extend at a 90° angle to the base region 60.

As may further be seen from the figures, the mechanical seal arrangement 1 comprises an axially movable thrust ring 7. The thrust ring 7 is arranged at a rear side 43 of the stationary slide ring 4 between the slide ring carrier 6 and the stationary slide ring 4. Thereby, the thrust ring 7 is arranged between the two extension regions 61, 62 of the slide ring carrier 6.

Furthermore, a pretensioning device 8 is provided, which is arranged between the thrust ring 7 and the slide ring carrier 6 and is configured to pretension the stationary sliding ring 4 in the axial direction X-X. The pretensioning device 8 comprises a plurality of separate spring elements, for example cylinder springs, arranged along the circumference.

Furthermore, the mechanical seal arrangement 1 comprises an anti-rotation device 10 for keeping the thrust ring 7 and the stationary sliding ring 4 rotationally in a fixed and axially movable state. The anti-rotation device 10 comprises a first transmission device 11 for transmitting force between the slide ring carrier 6 and the thrust ring 7, and a second transmission device 12 for transmitting force between the thrust ring 7 and the stationary sliding ring 4. In this example embodiment, the first transmission device 11 and the second transmission device 12 are each formed by a plurality of cylindrical pins.

FIG. 2 shows a sectional view of the anti-rotation device 10 and the first transmission device 11. Herein, a cylindrical pin of the first transmission device 11 is shown, which is fixed in the base region 60 of the slide ring carrier 6 by means of a first press fit 51. The cylindrical pin is guided through the thrust ring 7 in a through opening 70 and projects into a first recess 41 on the rear side 43 of the stationary sliding ring 4. Furthermore, a locking element 13 in the form of a locking washer is arranged on the cylindrical pin. As may further be seen from FIG. 2, a second recess 71 is also formed in the thrust ring 7, the through opening 70 opening into the second recess 71.

The second transmission device 12 may be seen in detail in FIG. 3. The second transmission device 12 also comprises a plurality of cylindrical pins which are fixed in the thrust ring 7 by means of a second press fit 52. Herein, a third recess 42 is provided on the rear side 43 of the stationary sliding ring 4 for receiving the cylindrical pin of the second transmission device 12 with clearance 44.

As may in particular be seen from FIGS. 1 and 2, the first transmission device 11, by means of the locking element 13, ensures that the thrust ring 7 is not completely ejected in the axial direction (to the right in FIG. 2) by the spring force of the pretensioning device 8 when disassembling the sliding rings.

The thrust ring 7 can be shifted in the axial direction X-X by a maximum length L until a bottom 71a of the second recess 71 rests against the locking element 13.

In this way, an anti-disengagement device may be realized which prevents the thrust ring 7 and the stationary sliding ring 4 from being outwardly ejected towards the assembly technician during disassembly of the mechanical seal arrangement 1, wherein disassembly is performed from the right side in FIG. 2. Thus, complete axial disengagement of the thrust ring 7 and also of the stationary sliding ring 4 can be avoided during disassembly.

Furthermore, as may be seen from FIGS. 1 to 3, a first secondary seal 17 is arranged on the radially inner circumference of the thrust ring 7 and a second secondary seal 18 is arranged on the radially outer circumference. The secondary seals 17, 18 are also located exposed to the rear side 43 of the stationary sliding ring 4. In the assembled state, the two secondary seals 17, 18 seal against the rear side 43 of the stationary sliding ring 4 and the first and second extension regions 61, 62.

The anti-disengagement device 10 also prevents the two secondary seals 17, 18 from being forced out of the slide ring carrier 6. This also allows easy disassembly and, more importantly, proper reassembly of the two secondary seals 17, 18 when revising the mechanical seal arrangement. After replacement of the secondary seals 17, 18, these are held in place by the anti-disengagement device and, by inserting the stationary sliding ring 4, are then moved back together with the thrust ring 7 to the starting position shown in FIG. 2, i.e. to the left in FIG. 2. This ensures that no undesirable jamming or crushing of the secondary seals 17, 18 occurs during assembly of the stationary sliding ring 4, since the assembly path (length L) from the disengaged position of the thrust ring 7 to the operating position in the axial direction is only very short.

Thus, the anti-disengagement device 10 of the mechanical seal arrangement 1 can provide a disengagement device for the mechanical seal arrangement, which is simple in design and which can be produced at low cost. In particular, when assembling or disassembling is performed under severe conditions, for example off-shore or in hot or cold regions, safe and risk-free disassembling and assembling can be performed without ejecting components of the mechanical seal arrangement 1 towards an assembly technician by the action of the pretensioning device 8. Furthermore, the anti-rotation device 10 can ensure that in the event of inspection and replacement of the secondary seals 17, 18, these are not immediately damaged during assembly. No additional assembly aids are required for assembling and disassembling the mechanical seal arrangement. The mechanical seal arrangement 1 can be provided as an assembly and thus as a completely replaceable insert.

### Lit of Reference Numbers

1 Mechanical seal arrangement
2 Mechanical seal
3 Rotating sliding ring
4 Stationary sliding ring
5 Sealing gap
6 Slide ring carrier
7 Thrust ring
8 Pretensioning device
9 Sleeve
10 Anti-rotation device
11 First transmission device
12 Second transmission device
13 Locking element
14 Shaft
15 Product region
16 Atmosphere region
17 First secondary seal
18 Second secondary seal
19 Housing
30 Sliding surface
40 Sliding surface
41 First recess
42 Third recess
43 Back side
44 Clearance
51 First press-fit connection
52 Second press-fit connection
60 Base region
61 First axial outer extension region
62 Second axial inner extension region
70 Through opening
71 Second recess
71a Base
L Displacement length of thrust ring
X-X Axial direction

1. A mechanical seal arrangement comprising:
a mechanical seal having a rotating sliding ring and a stationary sliding ring defining a sealing gap between their sealing surfaces,
a slide ring carrier for holding the stationary sliding ring,
an axially movable thrust ring, which is arranged on a rear side of the stationary sliding ring between the slide ring carrier and the stationary sliding ring
a pretensioning device arranged between the thrust ring and the slide ring carrier for pretensioning the stationary slide ring in the axial direction of the mechanical seal arrangement, and
an anti-rotation device for keeping the stationary sliding ring in a rotationally fixed and axially movable state, the anti-rotation device having a first transmission device for transmitting force between the slide ring carrier and the thrust ring and a second transmission device for transmitting force between the thrust ring and the stationary sliding ring, and
wherein a locking element is arranged on the first transmission device to secure the thrust ring against axial disengagement.

2. The mechanical seal arrangement according to claim 1, wherein the first transmission device includes at least one pin, in particular a cylindrical pin.

3. The mechanical seal arrangement according to claim 2, wherein the locking element is a locking washer.

4. The mechanical seal arrangement according to claim 1, wherein the second transmission device includes at least one pin, in particular a cylindrical pin.

5. The mechanical seal arrangement according to claim 1, wherein the slide ring carrier comprises includes a base region and a first axial extension region, wherein the first axial extension region radially extends outside the stationary sliding ring.

6. The mechanical seal arrangement according to claim 5, wherein the slide ring carrier has a substantially C-shaped cross-section with the base region, the axially outer extension region and an axially inner extension region.

7. The mechanical seal arrangement according to claim 1, wherein the stationary sliding ring comprises includes a first recess for receiving the first transmission device.

8. The mechanical seal arrangement according to claim 1, wherein the thrust ring comprises includes a through hole, wherein the first transmission device is passed through the through hole.

9. The mechanical seal arrangement according to claim 1, wherein a first secondary seal and a second secondary seal is arranged on the thrust ring on the side facing the rear side of the stationary sliding ring.

10. The mechanical seal arrangement according to claim 1, wherein the rotating sliding ring is connected to a sleeve which is configured to be fixable to a rotatable component.
